(19) United States
(12) Patent Application Publication
(10) Pub. No.: US 2014/0309945 A1
(43) Pub. Date: Oct. 16, 2014

(54) GENOME SEQUENCE ALIGNMENT APPARATUS AND METHOD

(71) Applicants: SAMSUNG SDS CO., LTD., Seoul (KR); Industry-Academic Cooperation Foundation, Yonsei University, Seoul (KR)

(72) Inventors: Min Seo Park, Seoul (KR); Yun Ku Yeu, Seoul (KR); Sang Hyun Park, Seoul (KR)

(73) Assignees: SAMSUNG SDS CO., LTD., Seoul (KR); Industry-Academic Cooperation Foundation, Yonsei University, Seoul (KR)

(21) Appl. No.: 14/357,133

(22) PCT Filed: Nov. 23, 2012
(86) PCT No.: PCT/KR2012/009981

§ 371 Date: May 8, 2014

(30) Foreign Application Priority Data
Nov. 30, 2011 (KR) 10-2011-0126965

(51) Int. Cl. G06F 19/24

(52) U.S. Cl. CPC G06F 19/24
USPC 702/20

(57) ABSTRACT

Provided are a sequence alignment apparatus and method for searching a reference sequence for a candidate position matching with a fragment that is a portion of a read sequence, and mapping the reference sequence and the read sequence to each other based on the candidate position. Accordingly, it is possible to form an alignment permitting all variations and errors that may exist in a read sequence, to search the entire area of a read sequence for variations and errors, and to form an alignment with less computation without permitting backtracking, unlike existing sequence alignment technology.

### 1. TECHNICAL FIELD

The present disclosure relates to a sequence alignment apparatus and method, and more particularly, to a sequence alignment apparatus and method capable of forming an alignment permitting all variations and errors that may exist in a read sequence, capable of searching the entire area of a read sequence for variations and errors, and capable of forming an alignment with less computation without permitting backtracking.

### 2. BACKGROUND ART

Sequence alignment technology is widely used in the entire field of biology. For example, through a process of mapping a read sequence to a known reference sequence, it is possible to complete the genomic sequence of each individual, and moreover, to analyze a variation in sequence between individuals. A large sequencing project, such as the 1000 Genomes Project, is currently under way. When such development continues, it is possible to ultimately provide a personal genome analysis service, a customized medical system according to genetic information, and so on.

### 3. Technical Problem

The embodiments of the present disclosure are directed to providing a sequence alignment apparatus, method, and program capable of forming an alignment permitting all modifications and errors that may exist in a read sequence and capable of searching the entire area of a read sequence for variations and errors.

The embodiments of the present disclosure are also directed to providing a sequence alignment apparatus, method, and program capable of forming an alignment with less computation without permitting backtracking, unlike existing sequence alignment technology.

### 4. Technical Solution

According to an aspect of the present disclosure, there is provided a sequence alignment method for aligning a read sequence to a reference sequence, including: searching a reference sequence for a candidate position matched with a fragment, the fragment being a portion of a read sequence; and mapping the read sequence to the reference sequence on the candidate position.

The fragment may be a sequence having a predetermined length from an arbitrary position in the read sequence.

The predetermined length of the fragment may be determined based on a value of an average frequency with which the fragment appears in the reference sequence.

The average frequency may be determined according to a length of the reference sequence and a number of bases.

The searching a reference sequence for a candidate position may include selecting, in the reference sequence, at least one of a position exactly matched with the fragment and a position matched with the fragment within a predetermined error tolerance E.

The searching a reference sequence for a candidate position may include at least one operation of: searching the reference sequence for at least one position exactly matched with the fragment; and performing insertion, deletion, and/or substitution on the fragment within a predetermined error tolerance E, and then searching for at least one position matched with the reference sequence.

The mapping the read sequence to the reference sequence may include mapping a remaining sequence behind the fragment in the read sequence to a sequence behind the candidate position in the reference sequence.

The method may further include determining whether or not the remaining sequence matches with the reference sequence when a portion of the remaining sequence is inserted, deleted and/or substituted with another sequence within the error tolerance E.

The error tolerance E may be an error tolerance set for the reference sequence.

When a portion of the reference sequence behind the candidate position does not match with the remaining sequence behind the fragment in the read sequence, the mapping the read sequence to the reference sequence may include moving a starting position of the reference sequence for matching within the error tolerance E and rematching the remaining sequence to the reference position at the moved starting position.

The method may further include: when the fragment matches with the reference sequence, storing the fragment as a mapping fragment; and when there are portions of the remaining sequence behind the fragment matching with the reference sequence behind the candidate position within the error tolerance E, storing the matched portions as mapping fragments.

The method may further include connecting the mapping fragments to each other when the mapping fragments satisfy the following equation:

|Dᵣ(M₁,M₂)−D_{R}(M₁,M₂)|<E−E₀

where M₁ and M₂ are mapping fragments to be connected, Dᵣ(M₁, M₂) is a distance between the mapping fragments M₁ and M₂ in a read sequence, D_{R}(M₁, M₂) is a distance between the mapping fragments M₁ and M₂ in a reference sequence, E is an error tolerance for the read sequence, E₀ is a sum of error values included in the mapping fragments, and |Dᵣ(M₁, M₂)−D_{R}(M₁, M₂)| is an absolute value of a difference between Dᵣ(M₁, M₂) and D_{R}(M₁, M₂).

According to another aspect of the present disclosure, there is provided a computer-readable medium storing a program for implementing the method described above.

According to another aspect of the present disclosure, there is provided an apparatus for aligning a read sequence to a reference sequence, the apparatus including: a position selector configured to search a reference sequence for a candidate position matched with a fragment, the fragment being a portion of a read sequence; a mapping unit configured to map the read sequence to the reference sequence on the candidate position; and an alignment unit configured to align the read sequence with the candidate position when the reference sequence and the read sequence match with each other on the candidate position.

The fragment may be a sequence having a predetermined length from an arbitrary position in the read sequence.

The predetermined length of the fragment may be determined based on a value of an average frequency with which the fragment appears in the reference sequence, and the average frequency value may be determined according to a length of the reference sequence and a number of bases.

The position selector may be configured to select, in the reference sequence, at least one of a position exactly matching with the fragment and a position matching with the fragment within a predetermined error tolerance E.

The mapping unit may be configured to map a remaining sequence behind the fragment in the read sequence to a sequence behind the candidate position in the reference sequence, or map remaining sequences in front of and behind the fragment in the read sequence to sequences in front of and behind the candidate position in the reference sequence.

The error tolerance E may be an error tolerance set for the reference sequence.

The mapping unit may be configured to determine whether or not the reference sequence behind the candidate position and a remaining sequence behind the fragment in the read sequence matches with each other, and the mapping unit may be configured to move a starting position of the reference sequence for matching within the error tolerance E and rematch the remaining sequence to the reference position at the moved starting position, when a portion of the reference sequence behind the candidate position does not match with the remaining sequence behind the fragment in the read sequence.

The apparatus may further include a storage, wherein the mapping unit may be configured to store, when the fragment matches with the reference sequence, the fragment in the storage as a mapping fragment, and store, when there are portions of the remaining sequence behind the fragment matching with the reference sequence behind the candidate position within the set error tolerance E, the matched portions in the storage as mapping fragments.

The alignment unit may connect the mapping fragments to each other when the mapping fragments satisfy the following equation:

|Dᵣ(M₁,M₂)−D_{R}(M₁,M₂)|<E−E₀

where M₁ and M₂ are mapping fragments to be connected, Dᵣ(M₁, M₂) is a distance between the mapping fragments M₁ and M₂ in a read sequence, D_{R}(M₁, M₂) is a distance between the mapping fragments M₁ and M₂ in a reference sequence, E is an error tolerance permitted for the read sequence, E₀ is a sum of error values included in the mapping fragments, and |Dᵣ(M₁, M₂)−D_{R}(M₁, M₂)| is an absolute value of a difference between Dᵣ(M₁, M₂) and D_{R}(M₁, M₂).

### Advantageous Effects

According to one or more exemplary embodiments of the present disclosure, alignment may permit all variations/mutations and errors that may exist in a read sequence, and the entire area of a read sequence may be searched for variations and errors.

In addition, according to one or more exemplary embodiment of the present disclosure, it is possible to form an alignment with less computation without permitting backtracking, unlike existing sequence alignment technology, so that alignment speed may increase.

### BRIEF DESCRIPTION OF DRAWINGS

FIG. 1 is a block diagram of a computer-readable recording medium in which a program for performing a sequence alignment method according to an exemplary embodiment of the present disclosure;

FIG. 2 is a block diagram of a sequence alignment apparatus according to an exemplary embodiment of the present disclosure;

FIG. 3 is a flowchart illustrating a sequence alignment method according to an exemplary embodiment of the present disclosure; and

FIGS. 4 and 5 are diagrams illustrating a fragment mapping method according to an exemplary embodiment of the present disclosure.

### MODE FOR INVENTION

Exemplary embodiments will now be described more fully with reference to the accompanying drawings to clarify aspects, features, and advantages of the present disclosure. The disclosure may, however, be embodied in many different forms and should not be construed as being limited to the embodiments set forth herein. Rather, these embodiments are provided so that this disclosure will be thorough and complete, and will fully convey the concept of the present disclosure to those of ordinary skill in the art. It will be understood that when a component is referred to as being “on” another component, the components can be directly on the other component or intervening components.

Also, it will be understood that when an element (or component) is referred to as being operated or executed “on” another element (or component), the element (or component) can be operated or executed in an environment where the other element (or component) is operated or executed or can be operated or executed by interacting with the other element (or component) directly or indirectly.

It will be understood that when an element, component, apparatus, or system is referred to as including a component consisting of a program or software, the element, component, apparatus, or system can include hardware (e.g., a memory or a central processing unit (CPU)) necessary to execute or operate the program or software or another program or software (e.g., an operating system (OS) or a driver necessary for driving hardware), unless the context clearly indicates otherwise.

Also, it will be understood that an element (or component) can be realized by software, hardware, or software and hardware, unless the context clearly indicates otherwise.

The terms used herein are for the purpose of describing particular exemplary embodiments only and are not intended to be limiting. As used herein, the singular forms “a,” “an,” and “the” are intended to include the plural forms as well, unless the context clearly indicates otherwise. It will be further understood that the terms “comprises” and/or “comprising,” when used in this specification, do not preclude the presence or addition of one or more other components.

Hereinafter, the present disclosure will be described in detail with reference to the drawings. In the following description of particular embodiments, many details are provided so as to describe the embodiments in further detail and to aid in understanding the present disclosure. However, those of ordinary skill in the art will appreciate that the embodiments could be used without such details. In some cases, descriptions that are well known but have no direct relationship to the present disclosure will be omitted to prevent the present disclosure from being obscured.

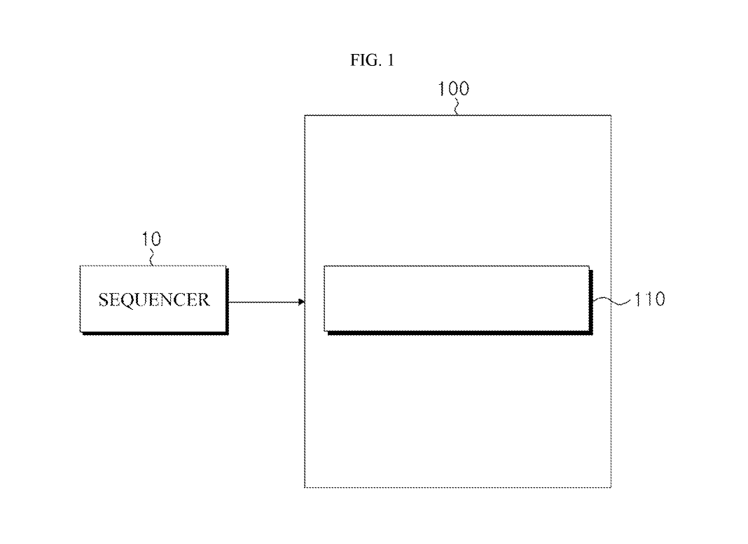

FIG. 1 is a block diagram of a computer-readable recording medium in which a program for performing a sequence alignment method according to an exemplary embodiment of the present disclosure.

Referring to FIG. 1, a sequence alignment apparatus 100 includes a computer-readable recording medium 110 in which a program for performing a sequence alignment method according to an exemplary embodiment of the present disclosure. To describe the present disclosure, a sequencer 10 is additionally shown.

The sequencer 10 generates a read sequence from a sample, and the sequence alignment apparatus 100 maps the read sequence generated by the sequencer 10 to a known reference sequence.

The sequence alignment apparatus 100 (referred to as “sequence apparatus 100” below) including the computer-readable recording medium in which the program for performing a sequence alignment method according to an exemplary embodiment of the present disclosure is recorded may perform exact matching based on sequence homology and also inexact matching that permits mismatching within an error tolerance E.

The sequence apparatus 100 according to the present embodiment searches a reference sequence for all mappable positions and determines the mappable positions as candidate positions in consideration of all combinable variations (deletion, substitution, or insertion) for a partial section of the read sequence (referred to as a “fragment” below). Here, the sequence apparatus 100 may search for a position matching with the fragment using a known mapping method (e.g., a method using the Burrows-Wheeler transform (BWT) and a suffix array).

According to an exemplary embodiment of the present disclosure, a start position of the fragment may be determined to be a first base in the read sequence. Alternatively, the start position of the fragment may be determined to be a second base in the read sequence. Alternatively, the start position of the fragment may be determined to be a third base in the read sequence. Alternatively, the start position of the fragment may be determined to be a random position between the first base in the read sequence to a base at half the length of the read sequence. For high accuracy, the position of the fragment is determined to be a section having a predetermined length from the first base of the read sequence, but the present disclosure is not limited to such a position.

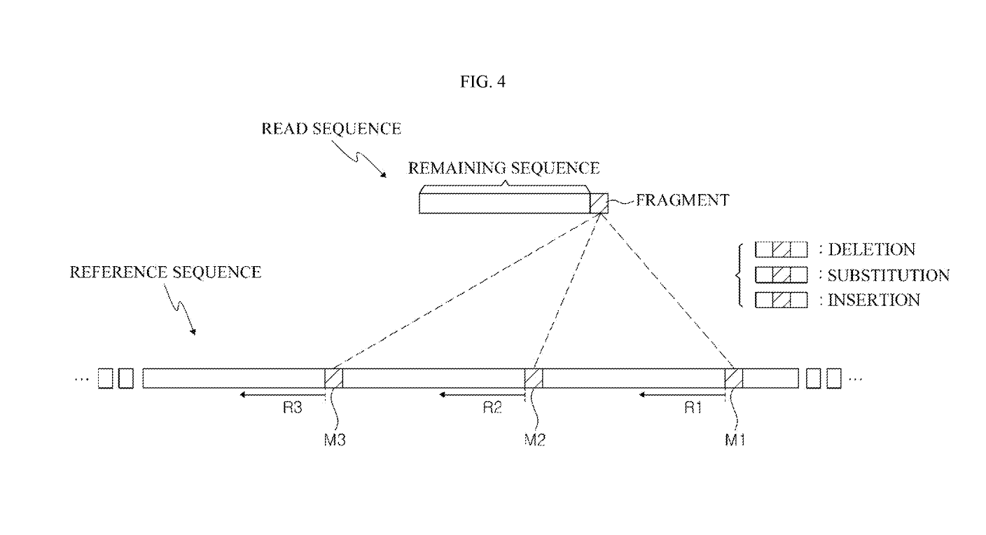

Referring to FIG. 4, the position of a fragment is selected to start from a first base of a read sequence, and three candidate positions M1, M2, and M3 that exactly matches the fragment or inexactly matches the fragment within the error tolerance E are shown as examples.

The sequence apparatus 100 compares a remaining sequence of the read sequence with a reference sequence based on the candidate positions. For example, the sequence apparatus 100 maps a reference sequence R1 right behind the candidate position M1 and the remaining sequence of the read sequence to each other, a reference sequence R2 right behind the candidate position M2 and the remaining sequence of the read sequence to each other, and a reference sequence R3 right behind the candidate position M3 and the remaining sequence of the read sequence to each other.

Meanwhile, when the fragment is not selected from the first position of the read sequence but is selected from any one of subsequent positions, remaining sequences are in front of and behind the fragment. In this case, the sequence apparatus 100 may map a reference sequence right in front of the candidate position as well as a reference sequence right behind the candidate position to the remaining sequences.

When matching is impossible while the sequence apparatus 100 is performing a mapping operation between the remaining sequence of the read sequence and reference sequences of the candidate positions M1, M2, and M3 (e.g., inexact-matching within the error tolerance E is not possible), the sequence apparatus 100 may jump a predetermined distance and then continue to perform the mapping operation. Here, the jump distance may be a value of the maximum error tolerance E according to the sequence length. For example, when the sum of error tolerances of previously selected candidate positions is k, the jump distance may be E−k or less.

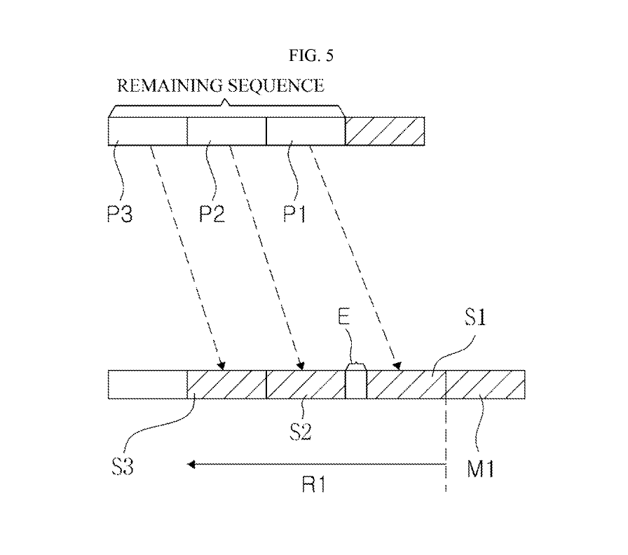

Alternatively, when matching is impossible while the sequence apparatus 100 is performing a mapping operation between the remaining sequence of the read sequence and reference sequences, a jump is not performed unconditionally but is performed only if a previous mapping result satisfies a minimum matching distance. Referring to FIG. 5, assuming that the remaining sequence of the read sequence is mapped to the reference sequence R1, the mapping unit 203 jumps the reference sequence position and continues to perform the mapping operation only if the length of the previously mapped area S1 is larger than the minimum matching distance when it is determined that matching is impossible at the reference sequence position E. When the length of the area S1 is smaller than the minimum matching distance, the mapping unit 103 performs no more mapping operation to the reference sequence R1.

When a mapping result between the remaining sequence of the read sequence and the candidate position M1 indicates as much matching as the minimum matching length mS or more, the sequence apparatus 100 stores such a matched portion as a mapping fragment (in FIG. 5, mapping fragments may be S1, S2, and S3, and a sequence of a candidate position may also be a mapping fragment).

When all mapping fragments up to the end of the read sequence are stored, the sequence apparatus 100 attempts to connect the stored mapping fragments. For example, the sequence apparatus 100 determines whether or not mapping fragments are connected based on a read sequence of a mapping fragment, information on a position of the mapping fragment in a reference sequence, and the maximum error tolerance E input as a parameter value.

For example, the sequence apparatus 100 connects mapping fragments when Equation 1 below is satisfied.

|Dᵣ(M₁,M₂)−D_{R}(M₁,M₂)|<E−E₀ [Equation 1]

Here, M₁ and M₂ are mapping fragments to be connected,

Dᵣ(M₁, M₂) is the distance between the mapping fragments M₁ and M₂ in a read sequence,

D_{R}(M₁, M₂) is the distance between the mapping fragments M₁ and M₂ in a reference sequence,

E is an error tolerance for the read sequence,

E₀ is the sum of error values included in the mapping fragments, and

|Dᵣ(M₁, M₂)−D_{R}(M₁, M₂)| is an absolute value of a difference between Dᵣ(M₁, M₂) and D_{R}(M₁, M₂).

The sequence apparatus 100 connects mapping fragments of connectable mapping fragment combinations using a known technique (e.g., the Needleman-Wunsch algorithm) or techniques to be found in the future.

Meanwhile, the length of a fragment may be determined based on the value of an average frequency with which a fragment appears in a reference sequence, and the average frequency value may be determined according to the length of the reference sequence and the number of bases in the reference sequence (i.e., A, G, C, and T). Also, the minimum matching length of mapping fragments may be determined to be the same as the length of a fragment.

Although not shown in the drawings, the sequence apparatus 100 may additionally include hardware and software resources necessary for the program to perform a sequence alignment method according to an exemplary embodiment of the present disclosure. Examples of hardware resources may be a CPU, a memory, a hard disk, and a network card, and examples of software resources may be an OS and a driver for driving hardware. For example, selection of a candidate position or a mapping operation is loaded onto a memory and then performed under the control of a CPU. In this way, to run programs stored in the recording medium 110, hardware resources and/or software resources are necessary. Interaction between these resources and the program stored in the recording medium 110 may be appreciated by those of ordinary skill in the art to which the present disclosure pertains.

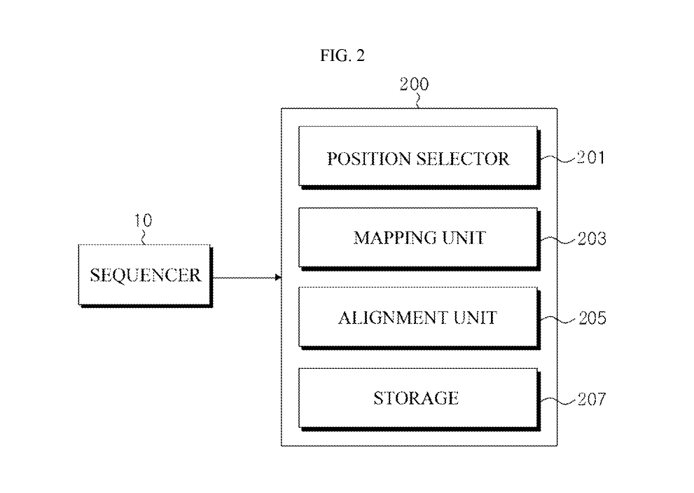

FIG. 2 is a block diagram of a sequence alignment apparatus according to an exemplary embodiment of the present disclosure.

Referring to FIG. 2, a sequence alignment apparatus 200 includes a position selector 201, a mapping unit 203, an alignment unit 205, and a storage 207. In FIG. 2 also, a sequencer 10 is additionally shown for description.

The position selector 201, the mapping unit 203, the alignment unit 205, and the storage 207 operate in harmony with each other to perform an operation that is the same as or similar to the operation of the sequence apparatus 100 described with reference to FIG. 1. Those of ordinary skill in the art to which the present disclosure pertains may implement the position selector 201, the mapping unit 203, and the alignment unit 205 as software and/or hardware.

The sequencer 10 generates a read sequence from a sample, and the sequence alignment apparatus 200 maps the read sequence generated by the sequencer 10 to a known reference sequence, thereby aligning the read sequence.

The position selector 201 searches a reference sequence for all mappable positions and determines the mappable positions as candidate positions in consideration of all combinable variations (deletion, substitution, or insertion) for a fragment.

As mentioned above, for high accuracy, the position of the fragment is determined to be a section having a predetermined length from the first base, but the present disclosure is not limited to such a position. In addition, as described in the embodiment of FIG. 1, the length of the fragment may be determined based on the value of an average frequency with which a fragment appears in a reference sequence, and the average frequency value may be determined according to the length of the reference sequence and the number of bases (i.e., A, G, C, and T).

The mapping unit 203 maps a remaining sequence of the read sequence to the reference sequence based on the candidate positions. Referring to the example of FIG. 4, the mapping unit 203 maps the reference sequence R1 right behind the candidate position M1 and the remaining sequence of the read sequence to each other, the reference sequence R2 right behind the candidate position M2 and the remaining sequence of the read sequence to each other, and the reference sequence R3 right behind the candidate position M3 and the remaining sequence of the read sequence to each other.

When matching is impossible while the mapping unit 203 is performing a mapping operation between the remaining sequence of the read sequence and the reference sequences of the candidate positions M1, M2, and M3 (e.g., inexact-matching within the error tolerance E is not possible), the mapping unit 203 may jump a predetermined distance and then continue to perform mapping. Here, the jump distance may be a value of the maximum error tolerance E given to the read sequence or less. For example, when the sum of error tolerances of previously selected candidate positions is k, the jump distance may be E−k or less.

Alternatively, when matching is impossible while the mapping unit 203 is performing a mapping operation between the remaining sequence of the read sequence and reference sequences, a jump is not performed unconditionally but is performed only if a previous mapping result satisfies a minimum matching distance. Referring to FIG. 5, assuming that the remaining sequence of the read sequence is mapped to the reference sequence R1, the mapping unit 203 jumps the reference sequence length E and continues to perform the mapping operation only if the length of the previously mapped area S1 is larger than the minimum matching distance when it is determined that matching is impossible at the reference sequence position E. When the length of the area S1 is smaller than the minimum matching distance, the mapping unit 103 performs no more mapping operation to the reference sequence R1.

When a mapping result between the remaining sequence of the read sequence and the candidate position M1 indicates as much matchnce as the minimum matching length mS or more, the mapping unit 203 stores such matched portions in the storage 207 as a mapping fragment (in FIG. 5, mapping fragments may be S1, S2, and S3, and a sequence of a candidate position may also be a mapping fragment).

When all mapping fragments up to the end of the read sequence are stored, the alignment unit 205 connects the stored mapping fragments. For example, the alignment unit 205 determines whether or not mapping fragments are connected based on information on positions of the mapping fragments in the read sequence and the reference sequence, and the maximum error tolerance E input as a parameter value.

For example, when Equation 1 above is satisfied, the alignment unit 205 may connect mapping fragments with respect to connectable mapping fragment combinations using a known technique (e.g., the Needleman-Wunsch algorithm) or techniques to be found in the future.

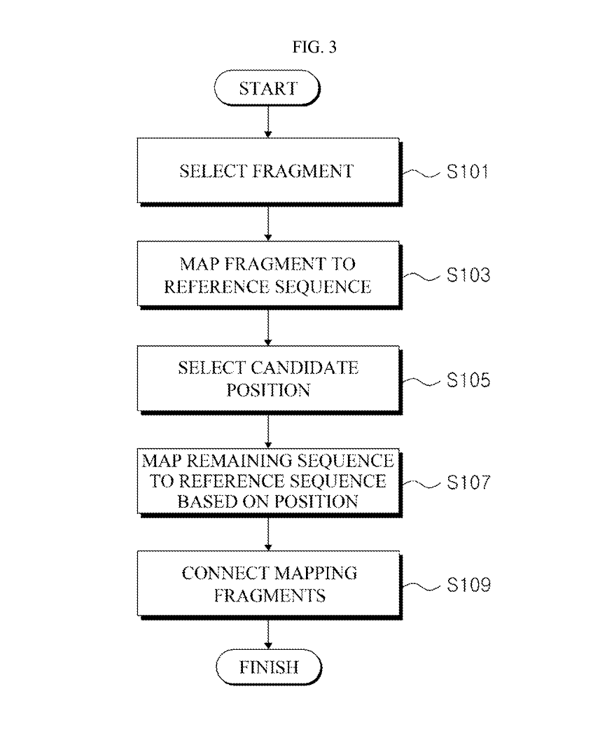

FIG. 3 is a flowchart illustrating a sequence alignment method according to an exemplary embodiment of the present disclosure.

Referring to FIG. 3, the sequence alignment apparatus 100 or 200 selects a fragment from a read sequence generated by the sequencer 10 (S101).

For high accuracy, the position of the fragment may be a first position of the read sequence, but is not limited to the first position. Likewise, the length of the fragment may be determined based on the value of an average frequency with which a fragment appears in a reference sequence so as to increase the speed of sequence alignment, but is not limited to the average frequency value.

The sequence alignment apparatus 100 or 200 maps the fragment selected in step 101 to the reference sequence (S103), and selects candidate positions that exactly match the fragment or match the fragment within an error tolerance (S105).

The sequence alignment apparatus 100 or 200 maps a remaining sequence of the read sequence to the reference sequence based on the candidate positions selected in step 105 (S107).

When mapping is impossible in step 107, the sequence alignment apparatus 100 or 200 may jump a distance within the maximum error tolerance.

The sequence alignment apparatus 100 or 200 connects mapping fragments that satisfy Equation 1 above (S109). In step 109, the sequence alignment apparatus 100 or 200 may fill empty spaces of the mapping fragments using a known technique or a technique to be developed in the future.

A sequence alignment apparatus and method according to the embodiments of the present disclosure described above may be used to search for a single nucleotide polymorphism (SNP), a multiple nucleotide polymorphism (MNP), an indel, an inversion, structural variations, a copy number variation (CNV), etc., and may be used in the entire field of biology, such as in transcriptome analysis and in a determination of a protein binding site for new drug development.

It will be apparent to those skilled in the art that variations can be made to the above-described exemplary embodiments of the present disclosure without departing from the spirit or scope of the present disclosure. Thus, it is intended that the present disclosure covers all such variations provided they come within the scope of the appended claims and their equivalents.

<Description of Reference Numbers>

| 10: Sequencer | 100, 200: sequence alignment apparatus |
|---|---|
| 201: position selector 203: mapping unit | |
| 205: alignment unit | 207: storage |

1. A method for aligning a read sequence to a reference sequence, the method comprising:
searching a reference sequence for a candidate position matched with a fragment, the fragment being a portion of a read sequence; and
mapping the read sequence to the reference sequence on the candidate position;
wherein the searching and the mapping are implemented at least in part by a hardware processor.

2. The method of claim 1, wherein the fragment has a predetermined length and begins at an arbitrary position in the read sequence.

3. The method of claim 1, wherein:
the fragment has a predetermined length; and
the predetermined length of the fragment is determined based on a value of an average frequency with which the fragment appears in the reference sequence.

4. The method of claim 3, wherein the average frequency is determined according to:
a length of the reference sequence, a total number of different bases contained in the reference sequence.

5. The method of claim 1, wherein the searching of the reference sequence for the candidate position includes selecting, in the reference sequence, at least one of:
a position exactly matched with the fragment, and
a position matched with the fragment within a predetermined error tolerance E.

6. The method of claim 1, wherein:
the searching of the reference sequence for the candidate position includes at least one operation of:
searching the reference sequence for at least one position exactly matched with the fragment; and
performing a modification operation on the fragment within a predetermined error tolerance E, and then searching for at least one position matched with the reference sequence, and
the modification operation on the fragment is at least one of an insertion, a deletion, and a substitution operation.

7. The method of claim 6, wherein the mapping of the read sequence to the reference sequence includes mapping a remaining sequence, behind the fragment in the read sequence, to a sequence behind the candidate position in the reference sequence.

8. The method of claim 7, further comprising determining whether the remaining sequence matches with the reference sequence when the modification operation is performed on a portion of the remaining sequence within the error tolerance E.

9. The method of claim 8, wherein the error tolerance E is an error tolerance set for the reference sequence.

10. The method of claim 9, wherein, when a portion of the reference sequence behind the candidate position does not match with the remaining sequence behind the fragment in the read sequence, the mapping of the read sequence to the reference sequence is performed so as to include:
moving a starting position of the reference sequence, for matching, within the error tolerance E and
rematching the remaining sequence to the reference position at the moved starting position.

11. The method of claim 9, further comprising:
responding to a match between the fragment and the reference sequence by storing the fragment as a mapping fragment; and
when portions of the remaining sequence behind the fragment match, within the error tolerance E, with the reference sequence behind the candidate position, storing the matched portions as mapping fragments.

12. The method of claim 11, further comprising connecting the mapping fragments to each other when the mapping fragments satisfy the following equation:

|Dᵣ(M₁,M₂)−D_{R}(M₁,M₂)|<E−E₀
where:
M₁ and M₂ are mapping fragments to be connected,
Dᵣ(M₁, M₂) is a distance between the mapping fragments M₁ and M₂ in a read sequence,
D_{R}(M₁, M₂) is a distance between the mapping fragments M₁ and M₂ in a reference sequence,
E is an error tolerance for the read sequence,
E₀ is a sum of error values included in the mapping fragments, and

|Dᵣ(M₁, M₂)−D_{R}(M₁, M₂)| is an absolute value of a difference between Dᵣ(M₁, M₂) and D_{R}(M₁, M₂).

13. A computer program product comprising a non-transitory computer-readable medium and computer instructions configured to enable a hardware processor to implement:
a position selector configured to search a reference sequence for a candidate position matched with a fragment, the fragment being a portion of a read sequence;
a mapper configured to map the read sequence to the reference sequence on the candidate position; and
an aligner configured to align the read sequence with the candidate position when the reference sequence and the read sequence match with each other at the candidate position.

14. An apparatus intended for use in aligning a read sequence to a reference sequence, the apparatus comprising:
a position selector configured to search a reference sequence for a candidate position matched with a fragment, the fragment being a portion of a read sequence;
a mapper configured to map the read sequence to the reference sequence on the candidate position; and
an aligner configured to align the read sequence with the candidate position when the reference sequence and the read sequence match with each other at the candidate position
wherein at least one of the position selector, the mapper, and the aligner is implemented using a hardware processor.

15. The apparatus of claim 14, wherein the fragment of the read sequence is set by the position selector to have a predetermined length and to begin at an arbitrary position in the read sequence.

16. The apparatus of claim 14, wherein:
the predetermined length of the fragment is set based on a value of an average frequency with which the fragment appears in the reference sequence, and
the average frequency value is determined according to a length of the reference sequence and a total number of different bases contained in the reference sequence.

17. The apparatus of claim 14, wherein the position selector is further configured to select, in the reference sequence, at least one of:
a position exactly matching with the fragment, and
a position matching with the fragment within a predetermined error tolerance E.

18. The apparatus of claim 14, wherein the mapping unit is further configured to perform at least one of:
mapping a remaining sequence behind the fragment in the read sequence to a sequence behind the candidate position in the reference sequence, and
mapping remaining sequences in front of and behind the fragment in the read sequence to sequences in front of and behind the candidate position in the reference sequence.

19. The apparatus of claim 17, wherein the position selector is further configured to set the error tolerance E as an error tolerance for the reference sequence.

20. The apparatus of claim 19, wherein the mapping unit is configured to:
determine whether the reference sequence behind the candidate position and a remaining sequence behind the fragment in the read sequence match,
detect when a portion of the reference sequence behind the candidate position does not match with the remaining sequence behind the fragment in the read sequence, and
in response to the detection, move a starting position of the reference sequence for matching, within the error tolerance E, and rematch the remaining sequence to the reference position at the moved starting position.

21. The apparatus of claim 14, further comprising a storage, wherein:
when the mapping unit determines that the fragment matches with the reference sequence, the mapping unit stores the fragment in the storage as a mapping fragment, and
when portions of the remaining sequence behind the fragment match with the reference sequence behind the candidate position within the set error tolerance E, the mapping unit stores the matched portions in the storage as mapping fragments.

22. The apparatus of claim 21, wherein the alignment unit connects the mapping fragments to each other when the mapping fragments satisfy the following equation:

|Dᵣ(M₁,M₂)−D_{R}(M₁,M₂)|<E−E₀
where:
M₁ and M₂ are mapping fragments to be connected,
Dᵣ(M₁, M₂) is a distance between the mapping fragments M₁ and M₂ in a read sequence,
D_{R}(M₁, M₂) is a distance between the mapping fragments M₁ and M₂ in a reference sequence,
E is an error tolerance permitted for the read sequence,
E₀ is a sum of error values included in the mapping fragments, and

|Dᵣ(M₁, M₂)−D_{R}(M₁, M₂)| is an absolute value of a difference between Dᵣ(M₁, M₂) and D_{R}(M₁, M₂).
